(19) United States
(12) Patent Application Publication
(10) Pub. No.: US 2007/0256910 A1
(43) Pub. Date: Nov. 8, 2007

(54) Feed station for articles in automatic palletizing systems

(75) Inventor: Vittorio Cavirani, Provazzano-Neviano Degli Arduini (PR) (IT)

Correspondence Address: WILLIAM COLLARD;COLLARD & ROE, P.C., 1077 NORTHERN BOULEVARD, ROSLYN, NY, 11576, US

(73) Assignee: ELETTRIC 80 S.P.A

(21) Appl. No.: 11/799,477

(22) Filed: May 1, 2007

(30) Foreign Application Priority Data
May 2, 2006 (EP) 06425287.7

(51) Int. Cl. B65G 47/26

(52) U.S. Cl. 198/419.1; 53/543

(57) ABSTRACT

The feed station for articles in automatic palletizing systems or the like, comprising a supporting frame for article feeding means and temporary retention means of at least one of the articles which can be associated in terms of operation with the feeding means for the simultaneous feeding of a preset number of articles towards at least one pickup station.

The present invention refers to a feed station for articles in automatic palletizing systems.

With specific reference to lightweight articles such as rolls of paper, handkerchiefs, diapers or the like, the use is known of sorting and palletizing systems able to organise and align several packs of such articles on pallets for subsequent transport towards sales outlets, storage warehouses, etc.

The known systems are generally associated with at least one feed line for single packs featuring one or more articles and, eventually, at least one feed line for packages consisting of a preset number of packs, previously placed side by side according to a specific configuration and wrapped in a heat-shrink plastic wrapping.

In the case of feeding packages of packs, these are generally conveyed directly towards a pickup station able to transfer each pack to one or more subsequent grouping and positioning stations on a pallet.

In the case of feeding single packs, the system comprises means of preset angular rotation and translation able to arrange a preset number of packs side by side and then convey these to the pickup station.

In particular, the packs are aligned in series of preset number, depending on the quantity that can be picked up from the pickup station and needed for the subsequent grouping and positioning phases on a pallet.

These known systems present a number of drawbacks, including the need to create two distinct feed lines for the single packs and packages of packs, with considerable overall dimensions.

Furthermore, the presence of dedicated equipment such as the means of rotation and translation of the single packs considerably boosts general system costs.

The main aim of the present invention is to excogitate a feed station for articles in automatic palletizing systems that ensures greater flexibility, including for articles of different types and dimensions, and which at the same time makes it possible to reduce overall dimensions and curb general costs.

As part of such technical aim, another purpose of the present invention is to achieve the previous aims with a simple structure, of relatively practical implementation, safe use and effective operation, as well as of a relatively low cost.

The purposes expounded above are all achieved by this feed station for articles in automatic palletizing systems or the like, comprising a supporting frame for article feeding means wherein it comprises temporary retention means of at least one of said articles which can be associated in terms of operation with said feeding means for the simultaneous feeding of a preset number of said articles towards at least one pickup station.

Further characteristics and advantages of this invention will appear even more evident from the detailed description of a preferred, but not exclusive, form of embodiment of a feed station for articles in automatic palletizing systems, illustrated by way of non limiting example in the accompanying drawings, wherein:

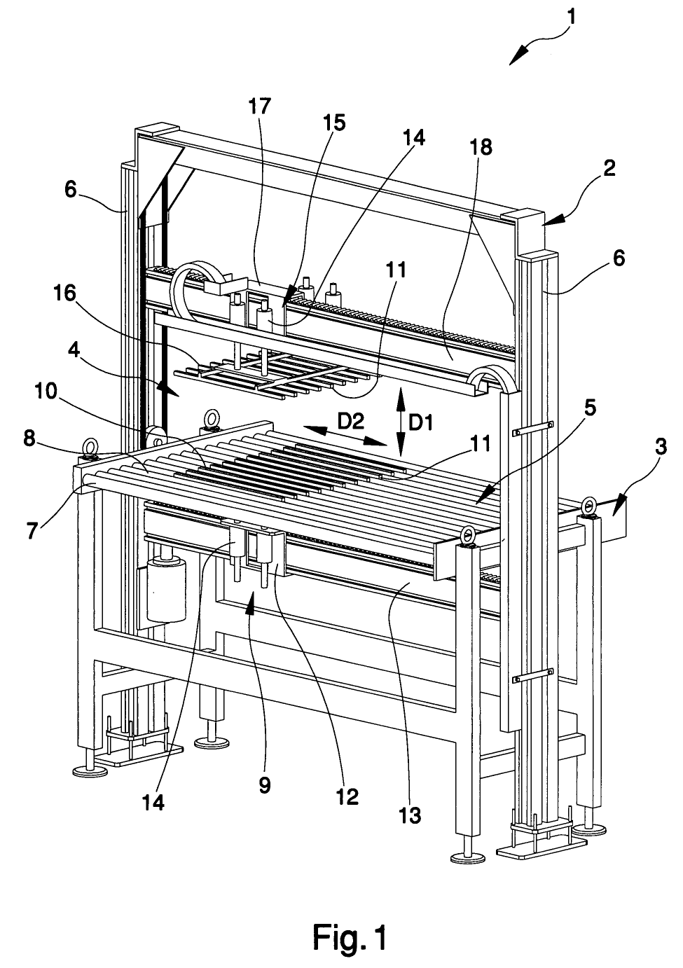

the FIG. 1 is a perspective view of the feed station according to the invention;

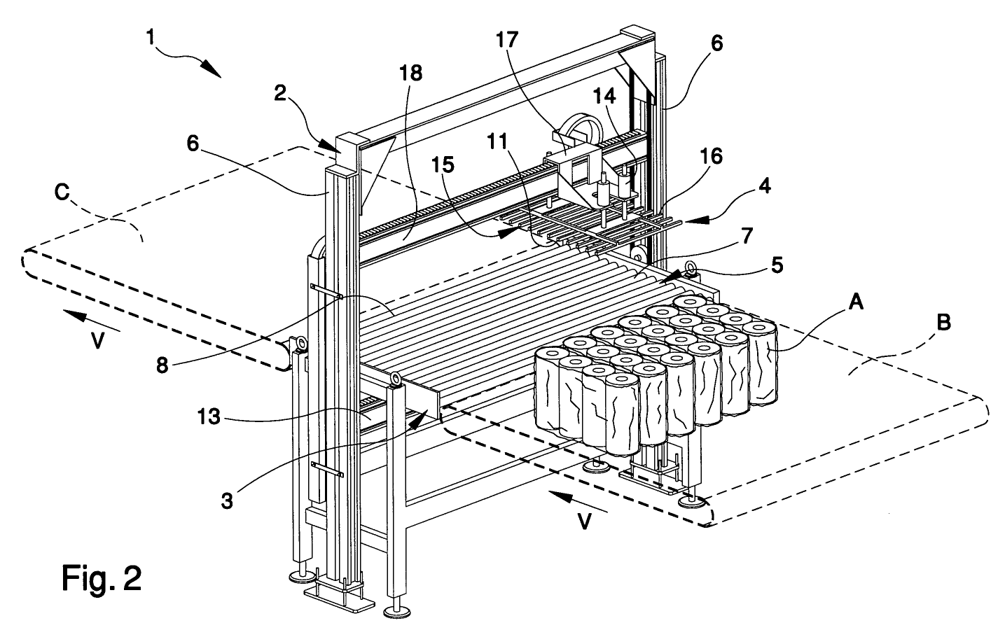

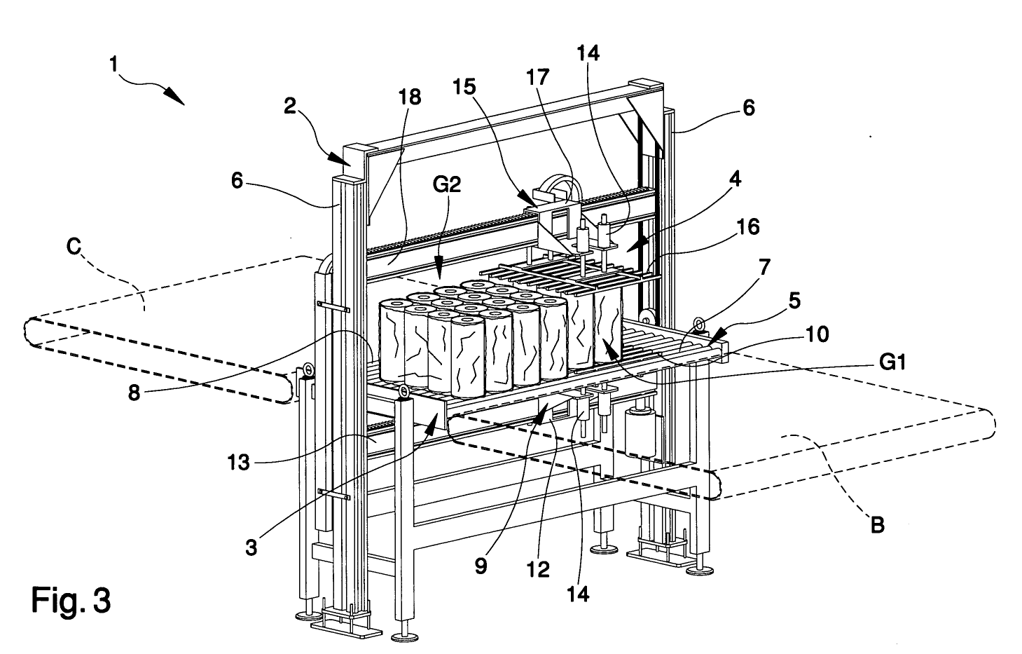

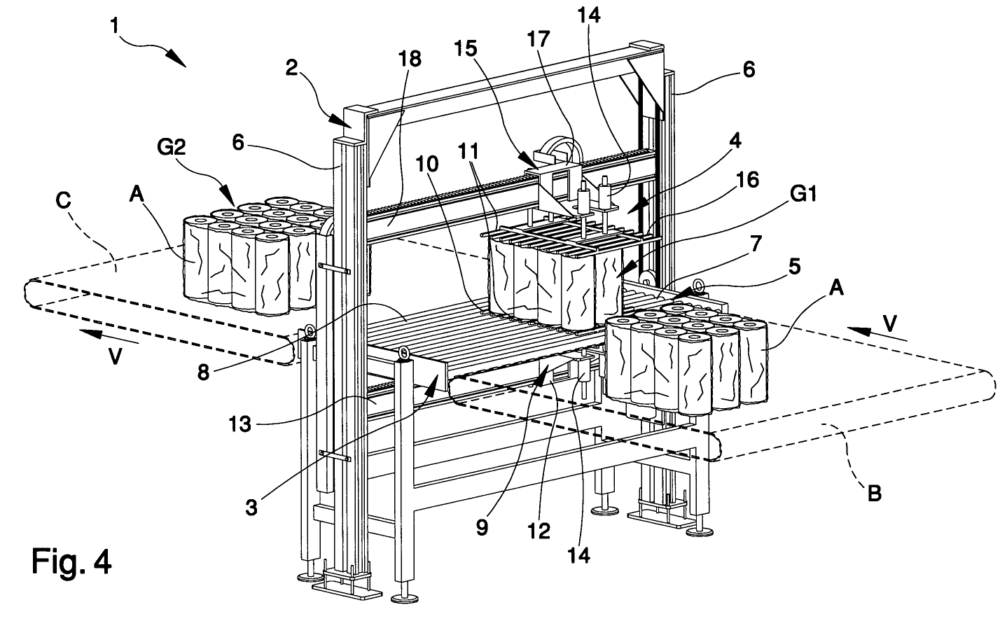

the FIGS. 2, 3 and 4 show three subsequent articles feeding phases at a point corresponding to the feed station, according to the invention.

With special reference to such figures, a feed station for articles in automatic palletizing systems has been generally designated by reference numeral 1.

In this current description, specific reference is made to lightweight articles such as handkerchiefs, toilet paper, diapers or the like, formed into packs A of one or more units. The application of the invention to different types of articles cannot however be ruled out.

Several packs A can be placed side by side and wrapped in shrink-wrap plastic material, before palletizing, upstream of the feed station 1.

The feed station 1 comprises a frame 2 supporting the feeding means 3 for the packs A, positioned upstream of a pickup station of a traditional type palletizing system.

The palletizing system is of the type commonly used and can feature, for example, a phase for the pickup of a series of aligned packs A and their conveyance towards a subsequent station to form a layer of several series arranged side by side. Several layers are subsequently positioned one on top of the other on a pallet for subsequent packaging and conveying.

The feeding means 3 are associated, in terms of operation, with the temporary retention means 4 of at least one of the packs A; in particular the feeding means 3 and the temporary retention means 4 cooperate together for the simultaneous feeding of a preset number of packs A, so as to form, downstream, a series of aligned packs A able to be picked up from the pickup station for the subsequent palletizing phases.

In particular, the feeding means 3 comprise a motorised roller conveyor 5, arranged substantially horizontal and associated with the frame 2 at a point corresponding to two uprights 6 positioned on opposite sides, with respect to the feed direction V of the packs A.

The motorised roller conveyor 5 is associated downstream of a feed line B of packs A (single packs A or several packs A associated together) and upstream of a conveyor line C of packs A towards the pickup station. In particular, the feed line B and the conveyor line C can, for example, be of the motorised conveyor belt type or the like.

Usefully, the motorised roller conveyor 5 comprises a plurality of rollers 7 arranged parallel and distanced to one another to define respective slots 8.

The temporary retention means 4 comprise a lifting part 9 of one or more articles by means of the motorised roller conveyor 5, which is movable along a first direction D1 substantially vertical (and orthogonal with respect to the surface defined by the motorised roller conveyor 5).

Usefully, the lifting part 9 comprises a first comb 10 featuring a plurality of rods 11 arranged substantially parallel and coplanar to one another.

In particular, the lifting part 9 is movable along the first direction D1 from a retracted position, in which the first comb 10 is arranged underneath the motorised roller conveyor 5, to a raised position, in which the first comb 10 is at least in part arranged above the feed surface of packs A defined by the motorised roller conveyor 5, or vice versa. During the switch from the retracted position to the raised position the rods 11 of the first comb 10 move through the slots 8 defined between one roller 7 and the roller that immediately follows.

The lifting part 9 is movable along a second direction D2 substantially horizontal and transversal with respect to the feed direction V of packs A.

In particular, the first comb 10 is supported by a first carriage 12 sliding on a first crosspiece 13 which is arranged below the motorised roller conveyor 5 and which is fastened at the ends to the uprights 6.

Usefully, the first carriage 12 slides on the first crosspiece 13 by means of motorised means and for the entire width of the motorised roller conveyor 5. This permits the positioning of the first comb 10 by the packs A to be lifted and the side movement (orthogonal to the feed direction) of the packs A once these have been lifted.

The height-variation actuators 14 of the first comb 10 (along the first direction D1), of the pneumatic linear actuator type, are placed between the first carriage 12 and the first comb 10.

Advantageously, the temporary retention means 4 comprise a tightening element 15 of one or more packs A on the first comb 10 in raised position, able to prevent accidental movements or falls of the packs A.

The tightening element 15 comprises a second comb 16, consisting of a plurality of rods 11 which are substantially parallel and coplanar to one another, and movable along the first direction D1 closer to and away (from a retracted position to a lowered position and vice versa) from the first comb 10, for tightening on one or more raised packs A.

In particular, the second comb 16 is supported by a second carriage 17 sliding on a second crosspiece 18, parallel with the first crosspiece 13, arranged above the motorised roller conveyor 5 and with its ends associated with the uprights 6. Advantageously, the second carriage 17 is supported sliding along the second crosspiece 18 by means of motorised means and for the entire width of the motorised roller conveyor 5, in a synchronous way and aligned (on a vertical axis) with respect to the first comb 10.

In actual fact, the first and the second comb 10 and 16 move simultaneously and aligned together along the second direction D2, and simultaneously and along the first direction D1 for the lifting and tightening of one or more packs A or for their release. Furthermore, the respective rods 11 define parallel surfaces so as to ensure a uniform grip on each of the retained packs A.

The height-variation actuators 14, of the pneumatic linear actuator type are placed between the second carriage 17 and the second comb 16 to allow their movement along the above first direction D1.

The feeding means 3 and temporary retention means 4 are, in terms of operation, associated with a management and control unit, of the microprocessor system type, of the PLC type or the like able to coordinate its movements (together with those of the feed line B and conveyor line C) for feeding the number of packs A required by the palletizing system towards the pickup station.

Advantageously, the movement of the first and second comb 10 and 16 along the first and the second direction D1 and D2 is piloted by the management and control unit according to the type of articles and to the number and dimensions of the packs A to be conveyed. This allows lifting by means of the first comb 10 and correct gripping by means of the second comb 16 including in the case of packs A of different dimensions or packages of such packs A.

The operation of the invention is as follows.

With special, but not limited, reference to the palletizing of packs A of articles of the paper roll type, as illustrated by way of example in FIGS. 2, 3 and 4, a determinate number of packs A, aligned the one with the other, move along the feed line B, until they take up a position on the motorised roller conveyor 5.

The first comb 10, initially arranged underneath the motorised roller conveyor 5, in retracted position, moves along the first crosspiece 13 and positions itself in line with a first group G1 of packs A to be retained.

The second comb 16, also in retracted position, moves along the second carriage 17 and along the second crosspiece 18 simultaneously and aligned with respect to the first comb 10.

Subsequently, the first and the second comb 10 and 16 translate by means of the actuators 14, coming closer together, lifting and gripping the first group G1 of packs A to be retained.

A second group G2 of packs A, not lifted and still positioned on the motorised roller conveyor 5, corresponds in terms of number to the packs A required for the subsequent palletizing phases. The motorised roller conveyor 5 moves the second group G2 towards the conveyor line C and towards the pickup station of the next palletizing system.

At this point, if the first retained group G1 consists exactly of the number of packs required by the pickup station for the subsequent palletizing operations, then this is released and continues towards the conveyor line C.

If this is not the case, and the number of packs A is higher than that required by the palletizing system, the first group G1 is split into further groups; in the event of the number of packs A being lower than that required, the first group G1 is aligned on the motorised roller conveyor 5 with a new group of packs A conveyed from the feed line B.

The feed procedure for the packs A towards the palletizing system then continues in the same way as described above.

In practice it has been found that the described invention achieves the intended purposes and more specifically emphasis is placed on the fact that the introduction of the feed system described above ensures greater flexibility of the whole palletizing system, including for articles of different types and dimensions, conveyed as a single pack or as packages of combined packs.

Another advantage is the possibility of using a single feed line for both single packs of articles and packages of several packs, with consequent huge reduction of the overall dimensions and general costs of the whole palletizing system.

The invention thus conceived is susceptible of numerous modifications and variations, all of which falling within the scope of the inventive concept.

Furthermore all the details can be replaced with others that are technically equivalent.

In practice, the materials used, as well as the shapes and dimensions, may be any according to requirements without because of this moving outside the protection scope of the following claims.

1) Feed station for articles in automatic palletizing systems or the like, wherein it comprise a supporting frame for article feeding means and temporary retention means of at least one of said articles which can be associated in terms of operation with said feeding means for the simultaneous feeding of a preset number of said articles towards at least one pickup station.

2) Station according to claim 1, wherein said retention means comprise at least one lifting part of at least one of said article with respect to said feeding means.

3) Station according to claim 2, wherein said lifting part is movable along a first direction substantially orthogonal with respect to the feed direction of said articles.

4) Station according to claim 3, wherein said first direction is substantially vertical.

5) Station according to claim 2, wherein said lifting part is movable along a second direction substantially transversal with respect to the feed direction of said articles.

6) Station according to claim 5, wherein said second direction is substantially horizontal.

7) Station according to claim 1, wherein said feeding means comprise a motorized roller conveyor.

8) Station according to claim 7, wherein said motorized roller conveyor is associated with said frame at a point corresponding to at least a pair of uprights.

9) Station according to claim 8, wherein said uprights are positioned on opposite sides with respect to the feed direction of said articles.

10) Station according to claim 7, wherein said motorised roller conveyor comprises a plurality of rollers arranged substantially parallel and distanced to one another.

11) Station according to claim 5, wherein said feeding means comprise a motorised roller conveyor and wherein said lifting part is movable along said second direction for the entire width of said motorised roller conveyor.

12) Station according to claim 2, wherein said lifting part comprises a first comb featuring a plurality of rods arranged substantially parallel and coplanar to one another.

13) Station according to claim 12, wherein said feeding means comprise a motorized roller conveyor and wherein the surface defined by said plurality of rods of said first comb is substantially parallel to the surface defined by said motorised roller conveyor.

14) Station according to claim 10, wherein said retention means comprise at least one lifting part of at least one of said article with respect to said feeding means, said lifting part comprising a first comb which features a plurality of rods arranged substantially parallel and coplanar to one another and being movable along a first direction substantially orthogonal with respect to the feed direction of said articles from a retracted position, in which said first comb is arranged underneath with respect to the surface defined by said motorised roller conveyor, to a raised position, in which said first comb is at least in part arranged above with respect to said surface, or vice versa, between said retracted position and said raised position, said rods being able to move through the slots defined between contiguous rollers of said motorised roller conveyor.

15) Station according to claim 8, wherein said retention means comprise at least one lifting part of at least one of said article with respect to said feeding means, said lifting part comprising a first comb which features a plurality of rods arranged substantially parallel and coplanar to one another and being movable along a second direction substantially transversal with respect to the feed direction of said articles, said first comb being supported by a first carriage sliding along said second direction on at least one first crosspiece which is arranged below said motorised roller conveyor and with its ends associated to said pair of uprights.

16) Station according to claim 2, wherein said retention means comprise at least one tightening element of said article on said lifting part.

17) Station according to claim 16, wherein said lifting part is movable along a first direction substantially orthogonal with respect to the feed direction of said articles and wherein said tightening element is movable along said first direction, close to and/or away from said lifting part.

18) Station according to claim 16, wherein said lifting part is movable along a second direction substantially transversal with respect to the feed direction of said articles and wherein said tightening element is movable along said second direction in a synchronous way and aligned with respect to said lifting part.

19) Station according to claim 8, wherein said retention means comprise at least one lifting part of at least one of said article with respect to said feeding means, said lifting part being movable along a second direction substantially transversal with respect to the feed direction of said articles, and wherein said retention means comprise at least one tightening element of said article on said lifting part, said tightening element being supported by a second carriage sliding along said second direction on at least one second crosspiece arranged above said motorised roller conveyor and with its ends associated with said pair of uprights.

20) Station according to claim 16, wherein said tightening element comprises a second comb featuring a plurality of rods arranged substantially parallel and coplanar to one another.

21) Station according to claim 20, wherein said lifting part comprises a first comb featuring a plurality of rods arranged substantially parallel and coplanar to one another and wherein said second comb defines a surface substantially parallel to the surface defined by said first comb.

22) Station according to claim 15, wherein said retention means comprise at least one tightening element of said article on said lifting part, said tightening element being supported by a second carriage sliding along said second direction on at least one second crosspiece arranged above said motorised roller conveyor and with its ends associated with said pair of uprights, and wherein said tightening element comprises a second comb featuring a plurality of rods arranged substantially parallel and coplanar to one another, at least one between said first comb and said second comb being associated with said first carriage or said second carriage respectively by interposition of at least one height-variation actuator.

23) Station according to claim 22, wherein said height-variation actuator is of the pneumatic type.

24) Station according to claim 15, wherein said retention means comprise at least one tightening element of said article on said lifting part, said tightening element being supported by a second carriage sliding along said second direction on at least one second crosspiece arranged above said motorised roller conveyor and with its ends associated with said pair of uprights, and wherein at least one between said first carriage and said second carriage is associated in terms of operation with motorised means able to slide along said first crosspiece and said second crosspiece respectively.

25) Station according to claim 1, wherein at least one between said feeding means and said retention means is associated in terms of operation with a management and control unit.

26) Station according to claim 25, wherein said management and control unit is of the microprocessor system type, of the PLC type or the like.
